(19) United States
(12) Patent Application Publication
(10) Pub. No.: US 2005/0179160 A1
(43) Pub. Date: Aug. 18, 2005

(54) Method for increasing the surface friction of sheet piling segments

(76) Inventor: Jeff Moreau, Kennesaw, GA (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/777,558

(22) Filed: Feb. 12, 2004

(51) Int. Cl. B32B 31/00

(52) U.S. Cl. 264/103; 264/136; 264/137; 264/236; 264/316; 264/293; 264/171.13

(57) ABSTRACT

A method of manufacturing a sheet piling that increases the surface friction on the sheet piling segments has been developed. The method includes pulling fibers pulling fibers through a bath of a base material and weaving the fibers into a matrix. The sheet piling is formed from the matrix and base material. Next, a fabric layer is placed on a side of the sheet piling and the sheet piling is cured. After curing the fabric layer is removed so that an abrasive surface is left on the side of the sheet piling.

### BACKGROUND OF THE INVENTION

1. Field of the Invention

The invention relates generally to the composition and structure of building materials. More specifically, the invention relates to a method for increasing the surface friction of sheet piling segments.

2. Background Art

Sheet piling is a construction material that is commonly used to build walls for the purpose retaining soil or water such as retaining sea-walls. The sheet piling is typically manufactured in individual segments that are attached to other segments to form a continuous wall. Since the segments are usually driven into the ground for stability, the segments may be several meters tall.

Sheet piling was once commonly made with steel or other metals. However, such piling may now be made with fiber re-enforced polymers (FRP). FRPs are formed out of a cured resin that has been re-enforced with fibers made of materials such as glass. The resin typically may be polyester or vinylester. While not as strong as steel, these materials offer better performance due to resistance to corrosion and other effects of chemical environments. Steel is an example of an “isotropic” material in that loads are distributed equally through out the material. In contrast, FRPs are generally considered “anisotropic” in that loads are not distributed equally in the material. For example, a composite material such as fiberglass is stronger along the orientation of the glass fibers than in other areas of the material.

One difficultly with the sheet piling segments involves positional slippage over time. This is particularly true for seawalls where the sheet piling segment has one side exposed to water and the other side exposed to soil. Over time, the pressure exerted by the soil may force the segment up from its installed position. This results in a rupture of the integrity of the seawall and a potential failure of the entire structure.

Additionally, given the smooth surface of the typical sheet piling segment, an analysis of the segment/soil relationship must occur in order to determine how the soil will react along the surface of the sheet piling. This relationship between the soil and the surface of the segment can be calculated and is referred to as a “delta value”. Due to traditionally smooth surfaces of sheet piling segments, engineers typically presume a lower delta value in their sheet piling design. A lower delta value will usually require the use of a longer sheet piling segment that is less economical and less efficient. Consequently, a method of increasing the surface friction of the sheet piling segments and consequently increasing the corresponding delta value is needed.

### SUMMARY OF THE INVENTION

In some aspects, the invention relates to a method of manufacturing a sheet piling, comprising: pulling fibers through a bath of a base material; weaving the fibers into a matrix; forming the sheet piling comprising the matrix and base material; placing a fabric layer on a side of the sheet piling; curing the sheet piling; and removing the fabric layer so that an abrasive surface is left on the side of the sheet piling.

In other aspects, the invention relates to a method of manufacturing a sheet piling, comprising: weaving fibers into a matrix; extruding a base material onto the matrix; forming the sheet piling comprising the matrix and base material; placing a fabric layer on a side of the sheet piling; curing the sheet piling; and removing the fabric layer so that an abrasive surface is left on the side of the sheet piling.

Advantages of the present invention include a method of manufacturing a sheet piling, comprising: step for forming the sheet piling with fibers and base material; and step for placing a fabric layer on a side of the sheet piling; step for curing the sheet piling; and step for removing the fabric layer so that an abrasive surface is left on the side of the sheet piling.

Other aspects and advantages of the invention will be apparent from the following description and the appended claims.

### BRIEF DESCRIPTION OF THE DRAWINGS

It should be noted that identical features in different drawings are shown with the same reference numeral.

FIG. 1 shows a view of a seawall using sheet piling segments in accordance with one embodiment of the present invention.

FIG. 2 shows an overhead view of two joined sheet piling segments in accordance with an alternative embodiment of the present invention.

FIG. 3 shows and overhead view of a joint of two joined sheet piling segments in accordance with one embodiment of the present invention.

FIG. 4 shows a view of a sheet a material added to a sheet piling segment to increase the surface friction in accordance with one embodiment of the present invention.

FIG. 5 shows a cross-sectional view of the surface of a sheet piling segment with an abraded surface area in accordance with one embodiment of the present invention.

### DETAILED DESCRIPTION

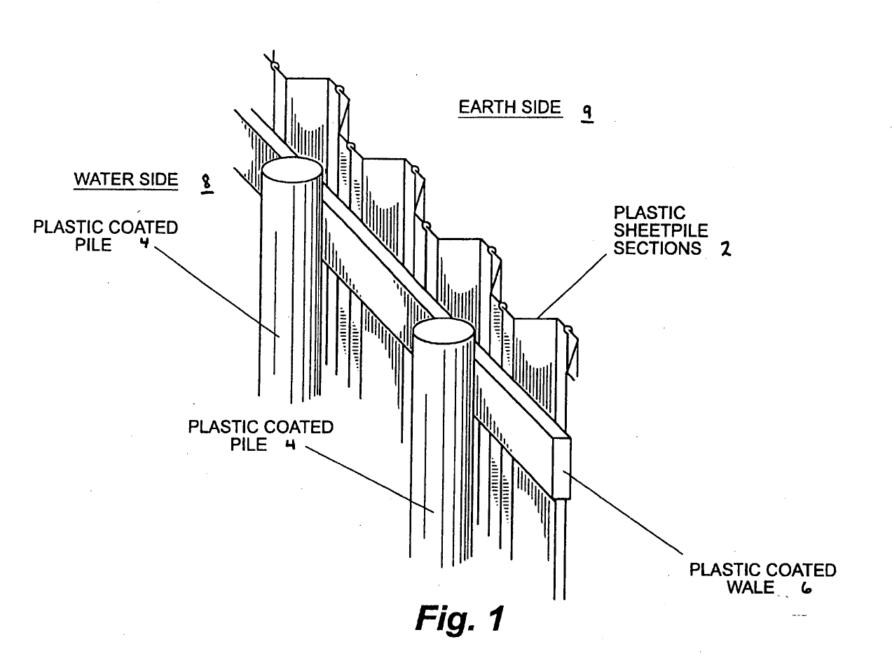

FIG. 1 shows a perspective view of one embodiment of an installed seawall with sheet piling segments. The sheet piling segments 2 are braced with piles 4 and wales 6 on the water side 8 to help support the segments 2. The other side of the sheet piling segments 2 is exposed to the earth side 9 of the seawall. The surface friction of this side of the sheet piling segments is increased with the present invention.

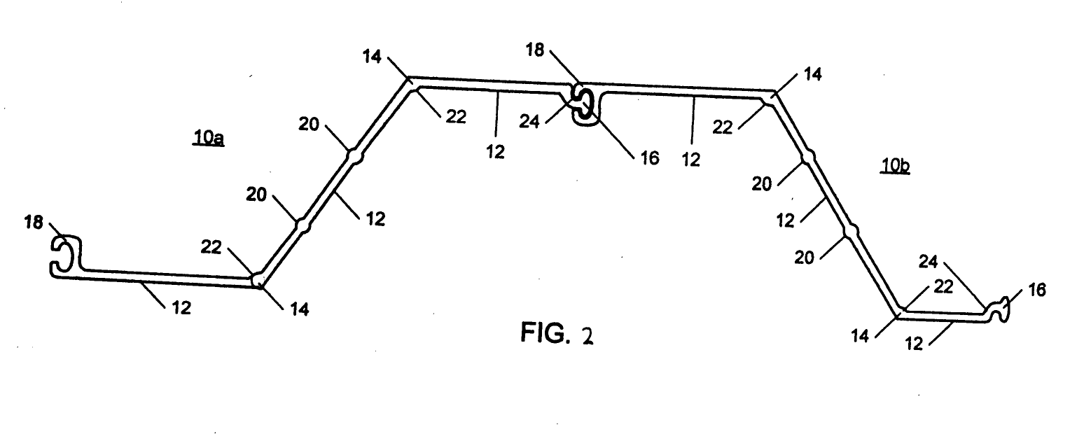

FIG. 2 shows an overhead view of two joined sheet piling segments 10a and 10b in accordance with one embodiment of the present invention. The two sheet piling segments or “sheets” shown are typically used in construction of seawalls in either freshwater or saltwater environments. In the present embodiment, each sheet 10a and 10b is made of three distinct panels 12 that are roughly configured in a “Z” shaped arrangement. Each panel fits with adjacent panels to form a corner 14 of the segment. The panels 12 form an angle of approximately 120° at each corner 14. In alternative embodiments, the number of panels in a segment of sheet piling may vary along with their relative angles to each other.

The two segments 10a and 10b are connected at a joint. One panel 10a has a male joint attachment 16, while the other panel 10b has a female joint attachment 18. These two attachments 16 and 18 fit together to form the joint that interlocks the segments 10a and 10b. Multiple segments are fitted together to form a length of wall. In this embodiment, each segment has a male joint attachment 16 and a female joint attachment 18 on alternative ends of the segment. In alternative embodiments, segments may have two male attachments or two female attachments.

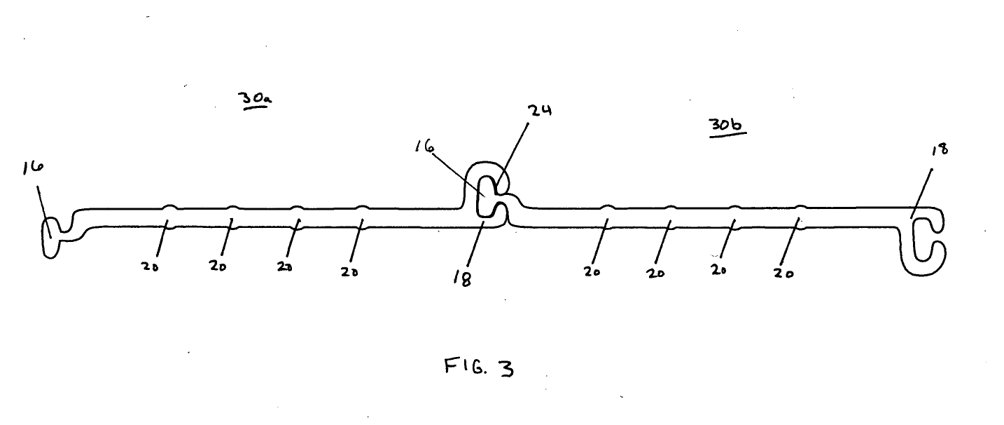

FIG. 3 shows an alternative embodiment of two joined sheet piling segments 30a and 30b. In this embodiment, the panels 30a and 30b are flat with respect to each other. Each panel 30a and 30b has an angle of 180° (i.e., it is flat) at its joints. In some embodiments, the dimensions of the sheet piling segment may be 18 inches long (i.e., the linear length from the male attachment to the female attachment of a segment) and 8 inches wide (i.e., the linear distance between the two end panels of the segment for the embodiment shown in FIG. 2). The segment may have a height of several feet or longer. The thickness of a panel of the segment may be 0.25 inches. In alternative embodiments, these dimensions may vary accordingly. In other embodiments, the sheet piling segment may be a corrugated sheet with multiple panels and other variations of size and shape of a pile segment that is driven into the soil. As such, it should be understood that the term “sheet pile” refers to any size or shape of structural material that is driven into the soil.

When the segments are used to construct a seawall, forces are exerted on the panels on one side by soil and on the other side by water. On the soil or earth side, these forces may dislocate the sheet piling segment over time. The segment can potentially shift laterally or vertically up out of the ground (called “lift”). In order to help prevent this, the surface friction of the side of the sheet piling segment that is exposed to the soil needs to be increased.

Friction is a resistive force that prevents two objects from sliding freely against each other (e.g., the sheet piling segment and the soil). Static friction is the force that holds back a stationary object (e.g., the sheet piling segment) up to the point that it begins moving. The mathematical formula for static friction is:
(F_{N})×(μ)=(F_{R})
where F_{N} is the perpendicular force applied to the object; μ is the coefficient of friction; and F_{R} is the resistive force of friction. The coefficient of friction (μ) varies among different types of materials. For example, a relatively smooth material such as glass has a lower coefficient of friction and consequently requires less force to overcome its static friction. Conversely, a relatively rough material such as sandpaper has a higher coefficient of friction and requires more force to overcome its static friction.

The sheet piling segments are typically made with a base plastic-type material that is extruded or fiber re-enforced plastic (FRP) products that are pultruded. Examples of pultruded materials include polyester, vinylester, and polyurethanes. The segments are manufactured by a process called “pultrusion”. With the pultrusion process, the fibers are pulled through a wet bath of the base material. The fibers are wetted with the material in the bath. The wet fibers are then cast into a matrix to increase the structural strength of the segment. The matrix may be a woven pattern whose design may vary to increase the strength of the finished product. The material is then pulled through a die where the segment of sheet piling is formed. The segment is then heat cured to solidify the base material and complete the manufacture of the segment. The fibers used in the process may be made of glass, carbon, or other suitable material that provides strength to the material.

In alternative embodiments, the segments may be manufactured by a process called “extrusion”. With the extrusion process, the matrix or “mat” of woven fibers is positioned in a mold and the base material is extruded or pushed through a cross-head die to form the composite material. The cross-head die is typically located at a 90° angle from the threads so that the extruded material is injected across the fibers.

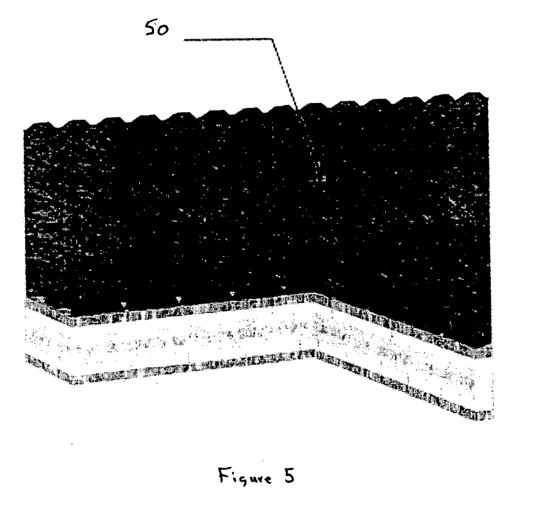

If the coefficient of friction of the sheet piling segments is increased, the segments will be more resistant displacement due to the forces exerted by the soil. The coefficient of friction may be increased by placing a woven layer of a fabric on one or both sides of the sheet piling segment after it is formed in the dye. After the segment is cured, the woven fabric layer is removed. It leaves behind an abrasive surface on one side of the sheet piling segment that is formed by the impression of the woven fabric. The abrasive surface of the segment with its increased coefficient of friction may then be installed facing the earth side of the seawall. FIG. 5 shows a cross-sectional view of an example of sheet piling segment with an abraded surface 50. This technique may be used in either the pultrusion or extrusion manufacturing processes.

In addition to reducing “lift”, a segment having an abraded or rough surface will also provide additional support for the soil used in backfilling of the structure. In the case of a granular fill material such as sand, the fill material will actually stack on the abraded surface. This maximizes the benefit of the soil's angle of internal friction.

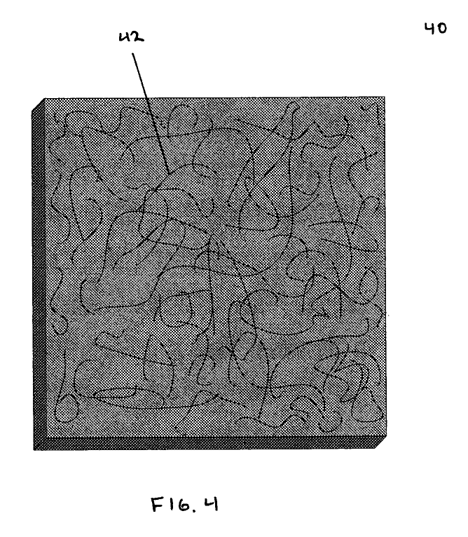

In some embodiments, the woven fabric layer may have a uniform knit pattern such as the “Peel Ply” Fabric that is manufactured by Precision Fabrics Group, Inc. The thickness of such a fabric may be 5-8 mils. The count of such materials may be a warp count of 57-160 ends/inch and a fill count of 35-103 picks/inch. In other embodiments, the fabric layer 40 may have a random pattern like the pattern 42 shown in FIG. 4.

The material used for the fabric layer may be polyester, nylon, kevlar or other suitable materials with the durability to withstand the curing process. In some embodiments, a layer may be used to cover the entire surface of the segment. In alternative embodiments, strips of fabric may cover only portions of the surface of the segment. Further, the strips may be arranged on the surface of the sheer piling segment in a random fashion.

While the invention has been described with respect to a limited number of embodiments, those skilled in the art, having benefit of this disclosure, will appreciate that other embodiments can be devised which do not depart from the scope of the invention as disclosed here.

1. A method of manufacturing a sheet piling, comprising:
pulling fibers through a bath of a base material;
weaving the fibers into a matrix;
forming the sheet piling comprising the matrix and base material;
placing a fabric layer on a side of the sheet piling;
curing the sheet piling; and
removing the fabric layer so that an abrasive surface is left on the side of the sheet piling.

2. The method of claim 1, where the fabric layer is placed on both sides of the sheet piling.

3. The method of claim 1, where the fabric layer is woven in a uniform pattern.

4. The method of claim 1, where the fabric layer is woven in a random pattern.

5. The method of claim 1, where the fabric layer comprises a plurality of strips of woven fabric.

6. The method of claim 5, where the plurality of strips of woven fabric are arranged in a random pattern.

7. The method of claim 1, where the fabric layer is made of polyester.

8. The method of claim 1, where the fabric layer is made of nylon.

9. The method of claim 1, where the fabric layer is made of kevlar.

10. The method of claim 1, where the fabric layer has a thickness of 5-8 mils.

11. The method of claim 1, where the fabric layer has a warp count of 57-160 ends per inch.

12. The method of claim 1, where the fabric layer has a fill count of 35-103 picks per inch.

13. The method of claim 1, where the sheet piling is flat.

14. The method of claim 1, where the sheet piling is corrugated.

15. The method of claim 1, where the sheet piling comprises a plurality of panels and each panel is joined to at least one other panel at an angle.

16. A method of manufacturing a sheet piling, comprising:
weaving fibers into a matrix;
extruding a base material onto the matrix;
forming the sheet piling comprising the matrix and base material;
placing a fabric layer on a side of the sheet piling;
curing the sheet piling; and
removing the fabric layer so that an abrasive surface is left on the side of the sheet piling.

17. A method of manufacturing a sheet piling, comprising:
step for forming the sheet piling with fibers and base material; and
step for placing a fabric layer on a side of the sheet piling;
step for curing the sheet piling; and
step for removing the fabric layer so that an abrasive surface is left on the side of the sheet piling.
